(19) United States
(12) Patent Application Publication
(10) Pub. No.: US 2024/0302572 A1
(43) Pub. Date: Sep. 12, 2024

(54) ANTI-REFLECTION FILM AND METHOD OF MANUFACTURING THE SAME

(71) Applicant: SAMSUNG ELECTRO-MECHANICS CO., LTD., Suwon-si (KR)

(72) Inventors: Jong Won YUN, Suwon-si (KR); Young Jin HWANG, Suwon-si (KR); Jai Dong LIM, Suwon-si (KR); Seong Ho EOM, Suwon-si (KR)

(73) Assignee: SAMSUNG ELECTRO-MECHANICS CO., LTD., Suwon-si (KR)

(21) Appl. No.: 18/442,635

(22) Filed: Feb. 15, 2024

(30) Foreign Application Priority Data
Mar. 6, 2023 (KR) 10-2023-0029463

(51) Int. Cl. G02B 1/111

(52) U.S. Cl. CPC G02B 1/111

(57) ABSTRACT

An anti-reflection film includes a substrate; a first layer, comprising a metal oxide film, disposed on the substrate; and a second layer, comprising a fluorinated organic thin film having pores, disposed on the first layer.

### CROSS-REFERENCE TO RELATED APPLICATIONS

This application claims the benefit under 35 USC 119(a) of Korean Patent Application No. 10-2023-0029463 filed on Mar. 6, 2023, in the Korean Intellectual Property Office, the entire disclosure of which is incorporated herein by reference for all purposes.

### BACKGROUND

### 1. Field

The following disclosure relates to an anti-reflection film and a method of manufacturing the same.

### 2. Description of the Background

Generally, an anti-reflective coating has a structure in which high and low refractive index materials are alternately vacuum-deposited and stacked.

A refractive index of a deposited thin film is based on the inherent properties of a material, so the range of adjustment is narrow, and there is a limit to a reduction in reflectance that can be achieved.

The recent lens market requires low reflectance, which is difficult to accomplish with the above-described multilayer thin film anti-reflective coating, so a new type of anti-reflective coating is desired.

In addition, anti-reflection films may be categorized into two types of films (a dry film and a wet film) depending on the production method.

Hot water treatment involves chemical reactions during an additional process of nanostructuring a vacuum-deposited thin film using the hot water treatment.

The industry generally adopts a water-based hot water treatment for easy process management. Still, there are issues, such as a change in hardness caused by moisture in the air and a reduction in yield caused by reaction residues.

In addition, as the eye level of customers becomes higher, the level of reflectance of anti-reflective coatings desired by the market is expected to decrease continuously. Accordingly, there is a need for nanostructured anti-reflective coating technology that can be mass-produced.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an anti-reflection film includes a substrate; a first layer, comprising a metal oxide film, disposed on the substrate; and a second layer, including a fluorinated organic thin film having pores, disposed on the first layer.

The anti-reflection film may further include an ultra-thin layer disposed on an uppermost surface of the second layer.

A refractive index of the first layer may be 1.7 or less.

A total volume ratio of voids in the second layer may be 20% or more relative to a total volume of the second layer.

The second layer may be formed of Teflon.

The second layer may include an organic material, including a fluorine group in an organic chain.

In another general aspect, a method of manufacturing an anti-reflection film, includes forming a first layer by vacuum-depositing a metal oxide film on a substrate, forming a fluorinated organic material layer by depositing a fluorinated organic material on the first layer, forming an ultra-thin film layer by depositing an ultra-thin film material on the fluorinated organic material layer, and forming a second layer by injecting accelerated ions onto the ultra-thin film layer and etching the fluorinated organic material layer.

At least a portion of the ultra-thin material may remain on an uppermost surface of the second layer to form an ultra-thin layer.

The first layer may be formed by depositing a metal oxide film having a refractive index of 1.7 or less.

The ultra-thin film material may have a wavelength in a visible light region, and the ultra-thin film material may include at least one of TiOₓ, ZnOₓ, TaOₓ, SiOₓ, ZrOₓ, CrOₓ, CuOₓ, WOₓ, and Voₓ, where x is 0.5 to 2.5.

The ultra-thin film material may have a thickness of 10 nm or less.

A total volume ratio of voids in the second layer may be 20% or more relative to a total volume of the second layer.

The second layer may be formed of Teflon.

The second layer may include an organic material, including a fluorine group in an organic chain.

Other features and aspects will be apparent from the following detailed description, the drawings, and the claims.

### BRIEF DESCRIPTION OF DRAWINGS

FIGS. 1 and 2 are schematic cross-sectional views of a process of manufacturing an anti-reflection film according to an example of the present disclosure.

FIGS. 3 to 6 are photographs illustrating FE-SEM and TEM results of a surface and a cross-section of an ultra-thin film material before etching.

FIGS. 7 to 10 are photographs illustrating FE-SEM and TEM results of a surface and a cross-section of an ultra-thin film layer after etching.

FIG. 11 is a schematic cross-sectional view of an anti-reflection film according to an example of the present disclosure.

FIG. 12 is a schematic perspective view of an anti-reflection film according to an example of the present disclosure.

FIG. 13 is a graph illustrating a reflectance of a central portion of a lens coated with a dry-type nanostructured anti-reflection film.

FIG. 14 is a graph illustrating a reflectance of an inclined surface of a lens coated with a dry-type nanostructured anti-reflection film.

FIG. 15 is a graph illustrating a reflectance of a central portion of a lens coated with a wet-type nanostructured anti-reflection film.

FIG. 16 is a graph illustrating a reflectance of an inclined surface of a lens coated with a wet-type nanostructured anti-reflection film.

FIG. 17 is a graph illustrating a reflectance of each of a central portion and an inclined surface of a lens coated with a dry-type nanostructured anti-reflection film after being left in an environment having a temperature of 85° C. and a humidity of 85% for 5 days.

FIG. 18 is a graph illustrating a reflectance of each of a central portion and an inclined surface of a lens coated with a wet-type nanostructured anti-reflection film after being left in an environment having a temperature of 85° C. and a humidity of 85% for 5 days.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

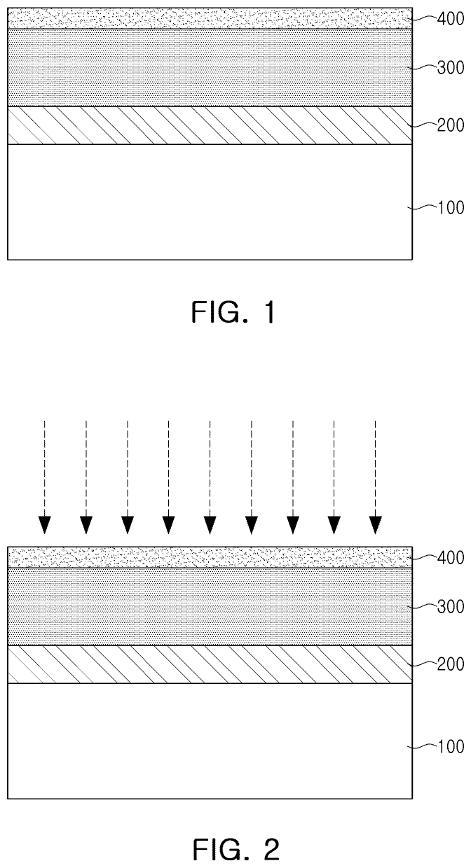

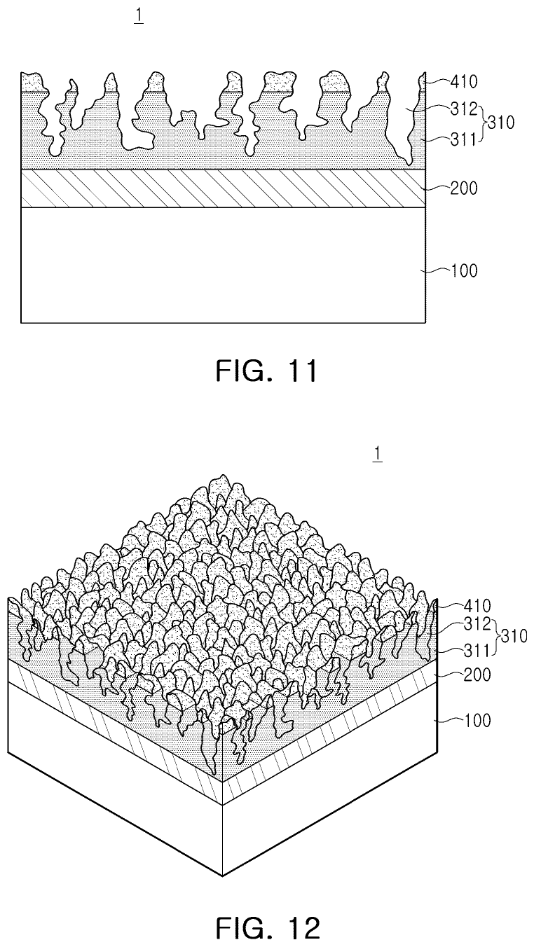

FIGS. 1 and 2 are schematic cross-sectional views of a process of manufacturing an anti-reflection film according to an example of the present disclosure. FIG. 11 is a schematic cross-sectional view of an anti-reflection film according to an example of the present disclosure. FIG. 12 is a schematic perspective view of an anti-reflection film according to an example of the present disclosure.

Referring to FIGS. 1, 2, 11, and 12, an anti-reflection film, according to an example of the present disclosure, may include a substrate 100, a first layer 200 disposed on one surface of the substrate 100, and a second layer 310 disposed on one surface of the first layer 200.

As desired, the first layer 200 may be formed on all other surfaces, including a cross-section of the substrate 100.

The first layer 200 may be formed of a metal oxide film.

The first layer 200 may be formed by depositing a metal oxide to prevent damage to the substrate 100 and to complement the anti-reflection performance of the second layer 310. In this case, deposition may be performed using various methods such as PVD, CVD, and ALD, and PVD may be used.

The etching of an organic material layer may occur rapidly, and all regions may not have the same etching depth.

In addition, the etching rate of the metal oxide film may be significantly lower than that of the organic thin film.

Accordingly, the first layer 200 formed of the metal oxide film may function as a layer preventing damage to the surface of the substrate 100 occurring after a region in which etching rapidly occurs.

In addition, it may be impossible to have a nanostructure in which an organic material layer becomes an ideal “graded-index layer” using a one-time etching process.

Improvements may be made by repeatedly performing a mask/etching process two or more times. However, the process may be complicated and incomplete.

Accordingly, in the present example embodiment, the first layer 200 may be formed by depositing a metal oxide film, including a material having a refractive index of 1.7 or less; ideally 1.5 or less, and an anti-reflective coating effect may be corrected by the first layer 200.

In addition, a thickness of the first layer 200 may be selected such that a region having high reflectance may be corrected according to a nanostructure shape of the second layer caused by a thickness, a material, and a mask shape of the second layer.

The second layer 310 may be formed of a fluorinated organic thin film having voids 312. In FIGS. 11 and 12, reference numeral 311 denotes a portion of the second layer 310 that is not etched.

For example, the second layer 310 may be formed by consecutively depositing a fluorinated organic material, having high moisture resistance, on one surface of the first layer 200.

The second layer 300 may function as a layer generating an ultra-low-reflection coating when an externally exposed region is etched by accelerated ions and is nanostructured accordingly.

In general, when the structure of a material is nano-sized, the surface activation energy thereof may rapidly increase.

Therefore, an organic material with high moisture resistance may be used when the second layer 310 is formed to prevent an issue in which a nanostructure changes due to exposure to atmospheric moisture.

In the present example embodiment, an organic material, including a fluorine group in an organic chain, may be used as an organic material having moisture resistance.

The fluorinated organic thin film may be formed of an organic material, including a fluorine group that is a hydrophobic thin film-forming material. The fluorinated organic thin film may be formed of a water-repellent coating or Teflon, which may have the advantage of no change in reflectance due to being left in the atmosphere, such as moisture or humidity.

In addition, dry treatment, according to the present disclosure, may not use a chemical reaction, and a nanostructured thin film may be formed on the second layer 310 only within a region in which a product is to be produced.

That is, there may be an advantage in that it is not affected by equipment for a process, such as a tray material other than the product.

In addition, the second layer 310 may be formed using dry-type etching, such that no additional reaction process may exist after vacuum deposition in wet-type etching, thereby reducing process time and preventing an increase in production costs.

In this case, deposition may be performed by various methods such as PVD, CVD, and ALD, and PVD may be used.

As a result, there may be no additional decrease in yield during a nanostructuring process, and a formation parameter of a nanostructured thin film may be controlled, which may have the advantages of controlling a nanostructure and enabling various applications.

When the voids 312 are formed in the second layer 310, as described above, an effective refractive index may be lowered, and an anti-reflection effect may be improved.

In this case, when a ratio of the voids 312 is gradually formed relative to a total area of the second layer 310, a layer referred to as “Graded-Index-Material” may be formed, and an anti-reflection film, capable of anti-reflective coating ideally converging to a reflectance of “0,” may be manufactured.

To increase an anti-reflection effect, a total volume ratio (space occupancy) of the voids 312 in the second layer 310 may be greater than or equal to 20% relative to a space occupied by the second layer 310 (that is, a total volume of the second layer).

When the total volume of the voids 312 of the second layer 310 is less than 20%, reflectance may increase. In this case, the space occupancy of the voids may be calculated by measuring the volume of the second layer before etching and the volume of the second layer after etching using ellipsometry.

In addition, according to another example embodiment of the present disclosure, the anti-reflection film may further include an ultra-thin layer formed on the uppermost surface of the second layer.

As described above, the anti-reflection film, according to the example embodiment, may be manufactured using dry treatment, a simpler process with no increase in reflectance in the atmosphere, and a controlled nanostructure, thus having high moisture resistance. As a result, there may be no change in reflectance in an atmospheric environment.

Referring to FIGS. 1 and 2, the anti-reflection film, according to the present disclosure, may be manufactured using the following method.

First, the first layer 200 may be formed on the substrate 100.

The first layer 200 may be formed by depositing a metal oxide film having a refractive index of 1.7 or less, the metal oxide film capable of preventing damage to the substrate 100 and complementing the no-reflection performance of a nanostructured thin film, using a vacuum deposition method such as PVD, CVD, or ALD.

Subsequently, a fluorinated organic material may be consecutively deposited on one surface of the first layer 200 to form a fluorinated organic material layer 300.

Subsequently, an ultra-thin film material 400, serving as an etching mask, may be consecutively deposited on one surface of the fluorinated organic material layer 300, such that the fluorinated organic material layer 300 may have a nanostructure after etching.

When deposited as an ultra-thin film, most materials may not form a complete thin film and may be deposited in a nanosized structure.

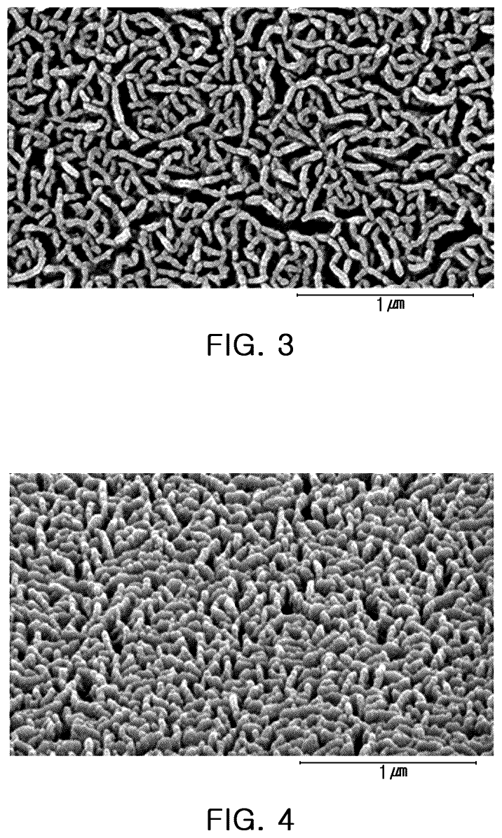

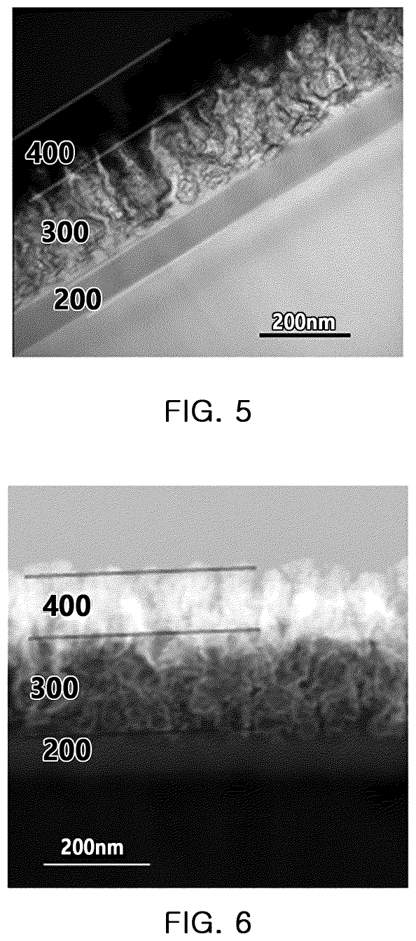

FIGS. 3 to 6 are photographs illustrating FE-SEM results of the surface of an ultra-thin film material before etching.

Referring to FIGS. 3 to 6, the ultra-thin film material 400, serving as an etching mask, may be structured to have a nano size to distinguish between exposure and shielding of the fluorinated organic material layer 300 formed of a fluorinated organic film, rather than a uniform thin film.

In this case, the ultra-thin film material 400 may also be based on an inorganic material. Thus, an etching rate may be significantly low compared to a fluorinated organic material of the fluorinated organic material layer 300.

Accordingly, when accelerated ions are injected into the surface of the ultra-thin film material 400, an exposed fluorinated organic material of the fluorinated organic material layer 300 may be rapidly etched, and a fluorinated organic material region of the fluorinated organic material layer 300, shielded by the ultra-thin film material 400, may be not etched or there may be a significant difference in etching time between the fluorinated organic material region of the fluorinated organic material layer 300, shielded by the ultra-thin film material 400, and a fluorinated organic material region of the fluorinated organic material layer 300, exposed by the ultra-thin film material 400.

Using such a process, the fluorinated organic material layer 300 may be nanostructured to form the second layer 310, as illustrated in FIG. 11.

In addition, the ultra-thin film material 400 may have no absorption at a wavelength requiring ultra-low reflection.

In a visible light region, a metal oxide film may be used, for example, TiOₓ, ZnOₓ, TaOₓ, SiOₓ, ZrOₓ, CrOₓ, CuOₓ, WOₓ, and VOₓ (here, x may be 0.5 to 2.5).

In addition, the thickness of the ultra-thin film material 400 may be 10 nm or less, e.g., 6 nm or less, and may be adjusted within a range that maintains a cluster shape depending on the properties of a material, that is, a range that does not form a complete thin film.

In this case, a mask interval may vary depending on the structural form of the ultra-thin film material 400, formed by selecting a material and controlling the thickness of the ultra-thin film material 400. As a result, a nanostructure of the second layer 310 may be adjusted, and a final reflectance of an anti-reflection film may be adjusted.

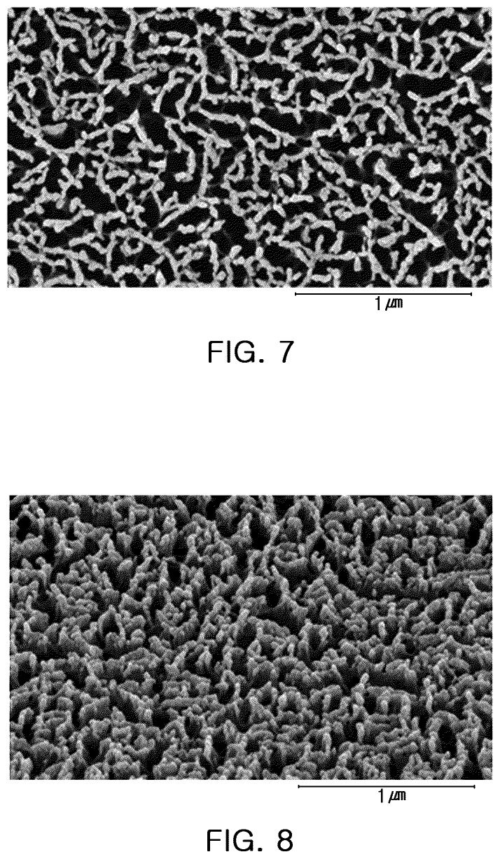

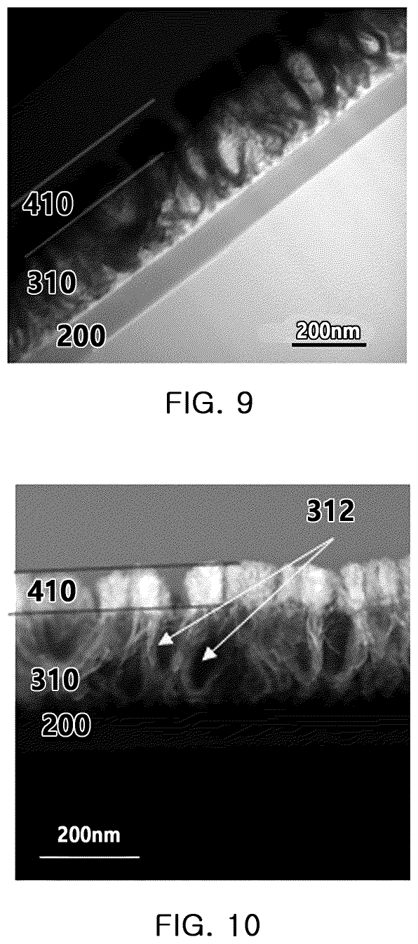

Subsequently, as illustrated in FIG. 2, accelerated ions may be injected into a deposition surface to etch the fluorinated organic material layer 300. Accordingly, an anti-reflection film may be manufactured, as illustrated in FIGS. 7 to 12.

In FIGS. 11 and 12, reference numeral 410 denotes an ultra-thin layer. After etching, at least a portion of the ultra-thin film material may remain on the uppermost surface of the second layer 310 to form the ultra-thin film layer 410.

In the anti-reflection film configured as described above, ultra-low reflection may be implemented by the nanostructured second layer 310 and the first layer 200, with a refractive index of 1.7 or less. Thus, the anti-reflection film may be applied to, for example, a lens to which NPS coating is applied, among mobile lenses, instead of hot water treatment.

In addition, the hot water treatment may involve a chemical reaction affected by the flow of a liquid. Thus, it may be difficult to precisely control the reflectance of an inclined surface in an intended direction, even when the thickness is adjusted before coating.

According to the example embodiment, the anti-reflection film may minimize a change in reflectance due to atmospheric exposure after being manufactured, reduce the manufacturing process, and eliminate additional yield reduction caused by a post-process of the hot water treatment, thereby reducing manufacturing time and costs.

In addition, the reflectance of an inclined surface of a curved lens may be easily controlled to implement various specifications.

Hereinafter, the reflectances of a central portion and an inclined lens surface may be compared when a nanostructured anti-reflection film is coated using a dry and hot water treatment, according to the present disclosure.

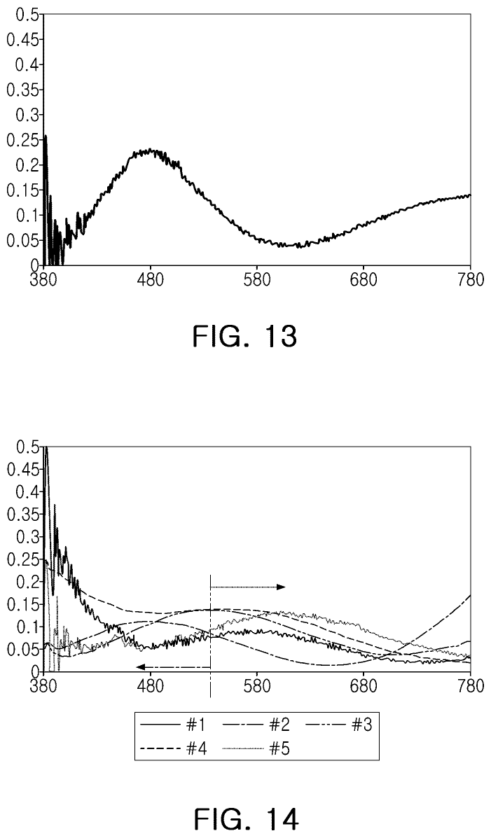

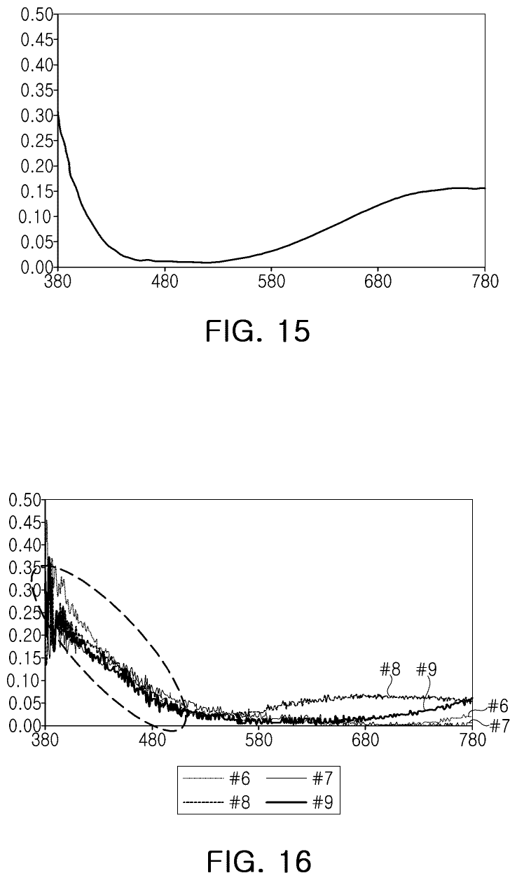

FIG. 13 is a graph illustrating the reflectance of a central portion of a lens coated with a dry-type nanostructured anti-reflection film. FIG. 14 is a graph illustrating the reflectance of an inclined surface of a lens coated with a dry-type nanostructured anti-reflection film. FIG. 15 is a graph illustrating the reflectance of a central portion of a lens coated with a wet-type nanostructured anti-reflection film. FIG. 16 is a graph illustrating the reflectance of an inclined surface of a lens coated with a wet-type nanostructured anti-reflection film.

Referring to FIGS. 15 and 16, it can be seen that, in the case of a lens coated with an anti-reflection film manufactured by forming a second layer using wet-type post-treatment after a fluorinated organic layer is coated with PVD, it is not possible to control a short-wavelength reflectance of an inclined surface in a dotted region.

In FIG. 16, #6 to #9 may be reflectances of wet-type NPS deposited by varying the thickness to control the reflectance of an inclined surface. Referring to FIG. 16, it can be seen that the reflectance of a short-wavelength region is not controlled even when the thickness is adjusted.

In order to resolve such an issue, coating using a CVD or ALD method may be desired. In this case, the costs desired for a process may greatly increase.

Conversely, referring to FIGS. 13 and 14, an anti-reflection film manufactured using dry treatment according to the present disclosure may easily control the reflectance of an inclined surface, even when a second layer is formed using a PVD method.

In other words, in FIG. 14, #1 to #5 may be reflectances of dry-type NPS having a thickness varying to control a reflectance of an inclined surface. Referring to FIG. 14, it can be seen that the reflectance of a short-wavelength region is controlled depending on the thickness.

In addition, in the present disclosure, a peak wavelength of reflectance of an inclined surface may be adjusted, thereby satisfying various flare colors desired by a product.

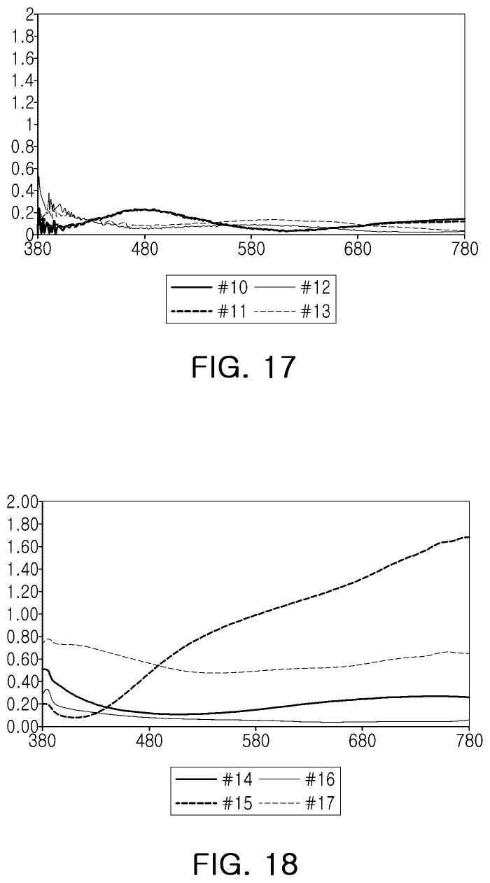

FIG. 17 is a graph illustrating a reflectance of each of a central portion and an inclined surface of a lens coated with a dry-type nanostructured anti-reflection film after being left in an environment having a temperature of 85° C. and a humidity of 85% for 5 days. FIG. 18 is a graph illustrating a reflectance of each of a central portion and an inclined surface of a lens coated with a wet-type nanostructured anti-reflection film after being left in an environment having a temperature of 85° C. and a humidity of 85% for 5 days.

Here, #10 may be data indicating a reflectance of a central portion of a lens immediately after being coated with an anti-reflection film, #11 may be data indicating a reflectance of a central portion of a lens 5 days after being coated with an anti-reflection film, #12 may be data indicating a reflectance of an inclined surface of a lens immediately after being coated with an anti-reflection film, and #13 may be data indicating a reflectance of an inclined surface of a lens 5 days after being coated with an anti-reflection film.

In addition, #14 may be data indicating a reflectance of a central portion of a lens immediately after being coated with an anti-reflection film, #15 may be data indicating a reflectance of a central portion of a lens 5 days after being coated with an anti-reflection film, #16 may be data indicating a reflectance of an inclined surface of a lens immediately after being coated with an anti-reflection film, and #17 may be data indicating a reflectance of an inclined surface of a lens 5 days after being coated with an anti-reflection film.

Referring to FIGS. 17 and 18, it can be seen that a lens using a wet-type anti-reflection film, according to the related art, has an increasing reflectance in a high humidity environment due to vulnerability to moisture and has a reflectance higher than that of a general multilayer anti-reflective coating.

Conversely, it can be seen that a lens using a dry-type anti-reflection film, according to the present disclosure, has almost no reflectance change at high temperature and high humidity.

The present disclosure provides an anti-reflection film manufactured using dry treatment and vacuum deposition coating. The anti-reflection film is capable of preventing a decrease in reflectance.

Another aspect of the present disclosure provides a method of manufacturing an anti-reflection film manufactured, using a dry treatment using vacuum deposition coating, the method capable of preventing a decrease in reflectance.

According to an aspect of the present disclosure, there is provided an anti-reflection film including a substrate, a first layer disposed on one surface of the substrate, the first layer formed of a metal oxide film, and a second layer disposed on one surface of the first layer, the second layer formed of a fluorinated organic thin film having pores.

According to example embodiments of the present disclosure, in nanostructured anti-reflective coating technology, an anti-reflection film may have a double-layer structure, a first layer may be formed of a metal oxide film, and a second layer may be formed of a fluorinated organic thin film having pores, thereby suppressing a gradual increase in reflectance of a coating film, manufactured using hot water treatment according to the related art, due to moisture in air.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An anti-reflection film comprising:
a substrate;
a first layer, comprising a metal oxide film, disposed on the substrate; and
a second layer, comprising a fluorinated organic thin film having pores, disposed on the first layer.

2. The anti-reflection film of claim 1, further comprising:
an ultra-thin layer disposed on an uppermost surface of the second layer.

3. The anti-reflection film of claim 1, wherein a refractive index of the first layer is 1.7 or less.

4. The anti-reflection film of claim 1, wherein a total volume ratio of voids in the second layer is 20% or more relative to a total volume of the second layer.

5. The anti-reflection film of claim 1, wherein the second layer is formed of Teflon.

6. The anti-reflection film of claim 1, wherein the second layer comprises an organic material, comprising a fluorine group in an organic chain.

7. A method of manufacturing an anti-reflection film, the method comprising:
forming a first layer by vacuum-depositing a metal oxide film on a substrate;
forming a fluorinated organic material layer by depositing a fluorinated organic material on the first layer;
forming an ultra-thin film layer by depositing an ultra-thin film material on the fluorinated organic material layer; and
forming a second layer by injecting accelerated ions onto the ultra-thin film layer and etching the fluorinated organic material layer.

8. The method of claim 7, wherein at least a portion of the ultra-thin material remains on an uppermost surface of the second layer to form an ultra-thin layer.

9. The method of claim 7, wherein the first layer is formed by depositing a metal oxide film having a refractive index of 1.7 or less.

10. The method of claim 7, wherein
the ultra-thin film material has a wavelength in a visible light region, and
the ultra-thin film material comprises at least one of TiOₓ, ZnOₓ, TaOₓ, SiOₓ, ZrOₓ, CrOₓ, CuOₓ, WOₓ, and Voₓ, where x is 0.5 to 2.5.

11. The method of claim 7, wherein the ultra-thin film material has a thickness of 10 nm or less.

12. The method of claim 7, wherein a total volume ratio of voids in the second layer is 20% or more relative to a total volume of the second layer.

13. The method of claim 7, wherein the second layer is formed of Teflon.

14. The method of claim 7, wherein the second layer comprises an organic material, comprising a fluorine group in an organic chain.
